(19) United States
(12) Patent Application Publication
(10) Pub. No.: US 2006/0181191 A1
(43) Pub. Date: Aug. 17, 2006

(54) Inner shield for slim cathode ray tubes

(75) Inventors: Min Ho Lim, Taegu-si (KR); Jin Tae Park, Kumi-si (KR)

Correspondence Address: BIRCH STEWART KOLASCH & BIRCH, PO BOX 747, FALLS CHURCH, VA, 22040-0747, US

(73) Assignee: LG. Philips Displays Korea CO., LTD., Kumi-si (KR)

(21) Appl. No.: 11/346,187

(22) Filed: Feb. 3, 2006

(30) Foreign Application Priority Data
Feb. 14, 2005 (KR) 2005-11953
Mar. 28, 2005 (KR) 2005-25554

(51) Int. Cl. H01J 29/80

(52) U.S. Cl. 313/402

(57) ABSTRACT

Disclosed herein is an inner shield for slim cathode ray tubes. On the assumption that the linear distance from an electron beam deflection center of a tube part to the plane formed by a seal edge of a panel is L, the height of the inner shield is Sh, the length of the major axis of an opening of the inner shield is Dx, the length of the minor axis of the opening is Dy, the short side bent angle is Sγ, the long side bent angle is Lγ, and the deflection angle is Dθ, the inner shield is constructed such that the following inequalities are satisfied: 2<L/Sh<3.5, 1.6<Dx/L<3.5, 1.0<Dy/L<2.5, 2.5<Dθ/Sγ<6.5, and 1.0<Dθ/Lγ<3.0. Furthermore, on the assumption that the area of a large opening α, and the area of a small opening is β, the ratio in area of the large opening to the small opening is set such that the following inequality is satisfied: 5.5>α/β>5.0.

### BACKGROUND OF THE INVENTION

1. Field of the Invention

The present invention relates to an inner shield for slim cathode ray tubes, and, more particularly, to an inner shield applicable to slim cathode ray tubes having a deflection angle of 110 degrees or more.

2. Description of the Related Art

FIG. 1 is a plan view, partially cut away, illustrating a conventional cathode ray tube. As shown in FIG. 1, the conventional cathode ray tube comprises a panel 1 and a funnel 2, which are joined with each other to constitute a tube part 10.

Inside the panel 1 is disposed a shadow mask 3, which is supported by a frame 4 such that the shadow mask 3 is approximately parallel with the panel 1. The frame 4 is fixed to the panel 1 via a spring 5. Inside the funnel 2 is disposed an inner shield 6 for isolating an external geomagnetic field to prevent the path of an electron beam from being curved by the external geomagnetic field.

In the rear part of the funnel 2 is fitted an electron gun 7 for generating an electron beam. At the outside of a neck part of the funnel 2 is mounted a deflection yoke 8 for deflecting an electron beam approximately 110 degrees or less.

In the conventional cathode ray tube with the above-stated construction, an electron beam emitted from the electron gun 7 is deflected above and below and right and left by the deflection yoke 8, and is then transmitted to the panel 1. Specifically, the deflected electron beam passes through-holes of the shadow mask 3, and is then transmitted to a fluorescent screen 9 coated on the inner surface of the panel 1. At this time, the fluorescent screen 9 is illuminated by the energy of the electron beam. Consequently, a picture is reproduced such that users can see the picture reproduced through the panel 1.

Meanwhile, the panel 1 and the funnel 2 are joined to each other at seal edges E by a frit sealing process, the electron gun 7 is fitted into the rear part of the funnel 2 by a subsequent encapsulation process, and a vacuum is formed in the tube part 10 by an extraction process. In this way, the cathode ray tube is manufactured.

When the cathode ray tube becomes slim, the deflection angle of the cathode ray tube is increased to 110 degrees or more, which is greater than that of a conventional cathode ray tube. As a result, halation is induced by a secondary electron beam colliding with the inner and outer walls of the inner shield 6, the funnel 2, and the panel 1 when scanning an electron beam.

Also, when openings of the inner shield 6 are not appropriately set, the electron beam collides with the inner shield 6 when overscanning the electron beam, and therefore, a shadow appears on the screen.

Specifically, when the conventional inner shield 6 with the above-stated construction is applied to slim cathode ray tubes having a deflection angle of 110 degrees or more, it is necessary to set the openings of the inner shield 6 such that an electron beam emitted from the electron gun 7 passes through the outermost through-holes of the shadow mask 3, without interference, to radiate the fluorescent body.

When the sizes of the openings of the inner shield 6 are too small, however, shadow is generated. When the sizes of the openings of the inner shield 6 are too large, on the other hand, halation is generated. Also, when the height of the inner shield 6 exceeds a predetermined level, interference is generated in the funnel 2, and therefore, assembly efficiency is lowered. When the height of the inner shield 6 is too small, on the other hand, halation is generated by a secondary electron beam reflected by the inner surface of the funnel 2 when the overscanned electron beam collides with the inner surface of the funnel 2. Furthermore, when the bent angle of the inner shield 6 deviates a predetermined level from the deflection angle, an electron beam emitted from the electron gun 7 is reflected by the inner surface of the inner shield 6 with the result that halation is generated.

Consequently, it is necessary to increase the ratio of the linear distance from the deflection center, the ratio of sizes of the openings of the inner shield 6 to the linear distance from the deflection center, and the ratio of the deflection angle to the side bent angles of the inner shield 6 to the optimal values applicable to the slim cathode ray tubes.

Meanwhile, the opposite openings of the inner shield 6 will be described with reference to FIG. 2.

The openings are formed at the opposite sides of the inner shield 6. Hereinafter, the opening formed at the panel 1 side will be referred to as a large opening 6L, and the opening formed at the electron gun 7 side will be referred to as a small opening 6S.

On the assumption that the horizontal length of the large opening 6L is a, the vertical length of the large opening 6L is b, and the area of the large opening 6L is a while the horizontal length of the small opening 6S is c, the vertical length of the small opening 6S is d, and the area of the small opening 6S is β, the conventional inner shield 6 is constructed in sizes indicated in Table 1 and Table 2 below.

TABLE 1
Unit: mm

| Model | a | b | c | d |
|---|---|---|---|---|
| 33 | 0.620 | 0.470 | 0.400 | 0.210 |
| 29 | 0.540 | 0.410 | 0.345 | 0.206 |
| 25 | 0.450 | 0.345 | 0.314 | 0.185 |
| 20 | 0.358 | 0.263 | 0.160 | 0.145 |
| 32 | 0.620 | 0.340 | 0.317 | 0.172 |
| 28 | 0.534 | 0.292 | 0.294 | 0.149 |

TABLE 2

Unit: m²

| Model | α | β | α/β | a/c | b/d |
|---|---|---|---|---|---|
| 33 | 0.291 | 0.084 | 3.5 | 1.55 | 2.24 |
| 29 | 0.221 | 0.071 | 3.1 | 1.57 | 1.99 |
| 25 | 0.155 | 0.058 | 2.7 | 1.43 | 1.86 |
| 20 | 0.094 | 0.023 | 4.1 | 2.24 | 1.81 |
| 32 | 0.211 | 0.055 | 3.9 | 1.96 | 1.98 |
| 28 | 0.156 | 0.044 | 3.6 | 1.82 | 1.96 |

The inner shield 6 is constructed such that the ratio in area of the large opening 6L to the small opening 6S (α/β) is approximately 2.7 to 4.1 as indicated in Table 2.

When the inner shield 6 constructed as described above is applied to slim cathode ray tubes having an increased deflection angle, i.e., a deflection angle of 110 degrees or more, however, it is required to set the openings of the inner shield 6 such that an electron beam emitted from the electron gun 7 passes through the outermost through-holes of the shadow mask 3 without interference to radiate the fluorescent body.

Furthermore, it is required that the entire volume of the inner shield be increased to increase the shielding efficiency of the inner shield 6 when the inner shield 6 is applied to the slim cathode ray tubes and that the sizes of the openings of the inner shield 6 be decreased to prevent the introduction of an external magnetic field.

### SUMMARY OF THE INVENTION

Therefore, the present invention has been made in view of the above problems, and it is an object of the present invention to provide an inner shield for slim cathode ray tubes, which is capable of preventing the generation of halation and shadow on the screen such that the inner shield can be applied to cathode ray tubes having a deflection angle of 110 degrees or more, preventing the decrease of the external magnetic field shielding efficiency even though the height of the inner shield is reduced in relation to the wide-angle deflection, and therefore, the volume of the inner shield is decreased, and accomplishing improved assembly efficiency.

In accordance with one aspect of the present invention, the above and other objects can be accomplished by the provision of an inner shield for slim cathode ray tubes, wherein, on the assumption that the linear distance from an electron beam deflection center of a tube part to the plane formed by a seal edge of a panel is L, and the height of the inner shield is Sh, the inner shield is constructed such that the following inequality is satisfied: 2<L/Sh<3.5, on the assumption that the length of the major axis of an opening at the electron beam entrance side of the inner shield is Dx, and the length of the minor axis of the opening at the electron beam entrance side of the inner shield is Dy, the inner shield is constructed such that the following inequalities are satisfied: 1.6<Dx/L<3.5 and 1.0<Dy/L<2.5, the inner shield has a wide-angle deflection of 120 degrees or more, and, on the assumption that the area of a large opening at the panel side is α, and the area of a small opening at the electron gun side is β, the ratio in area of the large opening to the small opening is set such that the following inequality is satisfied: 5.5>α/β>5.0.

In accordance with another aspect of the present invention, there is provided an inner shield for slim cathode ray tubes, wherein, on the assumption that the linear distance from an electron beam deflection center of a tube part to the plane formed by a seal edge of a panel is L, and the height of the inner shield is Sh, the inner shield is constructed such that the following inequality is satisfied: 2<L/Sh<3.5.

On the assumption that the length of the major axis of an opening at the electron beam entrance side of the inner shield is Dx, the inner shield is constructed such that the following inequality is satisfied: 1.6<Dx/L<3.5.

On the assumption that the length of the minor axis of an opening at the electron beam entrance side of the inner shield is Dy, the inner shield is constructed such that the following inequality is satisfied: 1.0<Dy/L<2.5.

On the assumption that the short side bent angle between the plane formed by an opening at the electron beam exit side of the inner shield and each short side is Sγ, and the deflection angle forming the maximum deflection from the center of an electron beam is Dθ, the inner shield is constructed such that the following inequality is satisfied: 2.5<Dθ/Sγ<6.5.

On the assumption that the long side bent angle between the plane formed by an opening at the electron beam exit side of the inner shield and each long side is Lγ, and the deflection angle forming the maximum deflection from the center of an electron beam is Dθ, the inner shield is constructed such that the following inequality is satisfied: 1.0<Dθ/Lγ<3.0.

In accordance with yet another aspect of the present invention, there is provided an inner shield for slim cathode ray tubes, wherein the inner shield has a wide-angle deflection of 120 degrees or more, and, on the assumption that the area of a large opening at the panel side is α, and the area of a small opening at the electron gun side is β, the ratio in area of the large opening to the small opening is set such that the following inequality is satisfied: 5.5>α/β>5.0.

On the assumption that the horizontal length of the large opening is a, the vertical length of the large opening is b, the horizontal length of the small opening is c, and the vertical length of the small opening is d, a and b of the large opening are double or more c and d of the small opening, respectively.

On the assumption that the horizontal length of the large opening is a, and the horizontal length of the small opening is c, a of the large opening is double or more c of the small opening.

On the assumption that the vertical length of the large opening is b, and the vertical length of the small opening is d, b of the large opening is double or more d of the small opening.

According to the present invention, the height of the inner shield and the sizes of the openings of the inner shield are appropriately set to construct the inner shield for slim cathode ray tube according to the present invention. Consequently, when the inner shield is applied to the slim cathode ray tube, interference is not generated between the inner shield and the funnel, and therefore, the assembly efficiency is improved, halation, which may be generated by an overscanned electron beam, is prevented, and the appearance of shadow on the screen is also prevented.

Furthermore, the inner shield for slim cathode ray tubes according to the present invention is constructed such that the area of the opening, through which the electron beam is introduced, is reduced, and therefore, the electron beam can be maximally enclosed by the inner shield. As a result, the height of the inner shield is reduced in relation to the wide-angle deflection, and therefore, the reduction of the external magnetic field shielding efficiency is prevented even though the volume of the inner shield is reduced. Consequently, the reliability of the shielding function is improved.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a plan view, partially cut away, illustrating a conventional cathode ray tube;

FIG. 2 is a front view illustrating a conventional inner shield;

FIG. 3 is a front view illustrating a slim cathode ray tube according to the present invention;

FIG. 4 is a plan view illustrating an inner shield according to the present invention;

FIG. 5 is a rear view illustrating the inner shield according to the present invention;

FIG. 6 is a side view illustrating the inner shield according to the present invention;

FIG. 7 is a schematic front view illustrating the ratio of openings of the inner shield according to the present invention;

FIG. 8 is a graph illustrating the relationship between the deflection angle of the cathode ray tube and the area ratio of the openings; and

FIGS. 9A to 9C are views illustrating raster patterns depending on the area of the openings of the cathode ray tube.

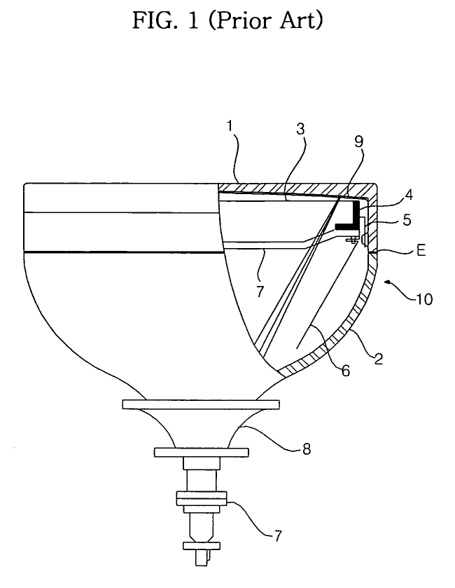

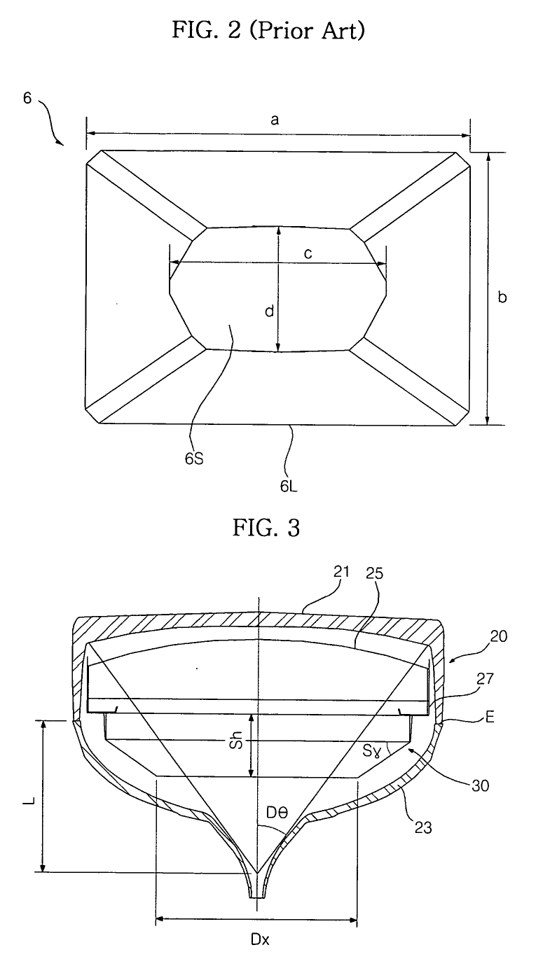

### DESCRIPTION OF THE PREFERRED EMBODIMENTS

Now, preferred embodiments of the present invention will be described in detail with reference to the accompanying drawings.

FIG. 3 is a front view illustrating a slim cathode ray tube according to the present invention.

As shown in FIG. 3, the slim cathode ray tube according to the present invention includes a panel 21 and a funnel 23, which are joined with each other, while seal edges E of the panel 21 and the funnel 23 are brought into contact with each other, to constitute a tube part 20. In the tube part 20 are mounted a shadow mask 25, a frame 27 for fixing the shadow mask 25 to the panel 21, and an inner shield 30 disposed at the frame 27 side for shielding an external geomagnetic field.

Especially, the inner shield 30 serves to prevent an electron beam from being directed to undesired screen positions due to an external magnetic field, such as a geomagnetic field, when the electron beam, which is emitted from an electron gun, is deflected by the deflection yoke, and then collides with a fluorescent body formed at the inner surface of the panel.

The slim cathode ray tube is constructed such that the electron beam has a deflection angle 2Dθ of 110 degrees or more, more preferably, 120 degrees or more. The inner shield 30 is constructed to prevent the generation of halation and shadow on the screen when the thickness of the cathode ray tubes is decreased.

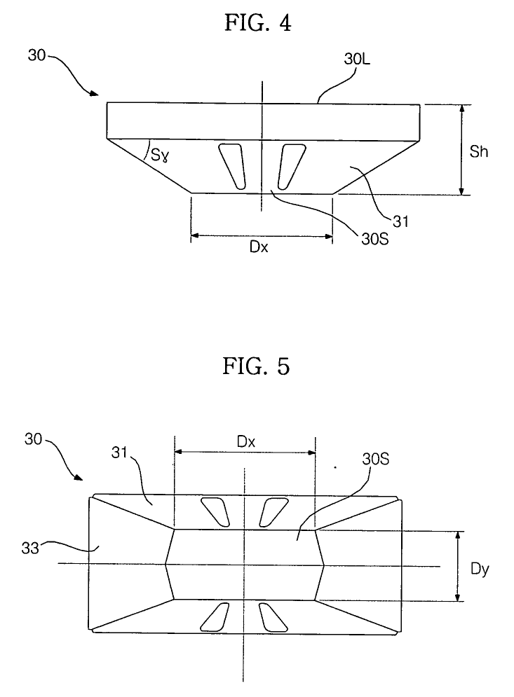

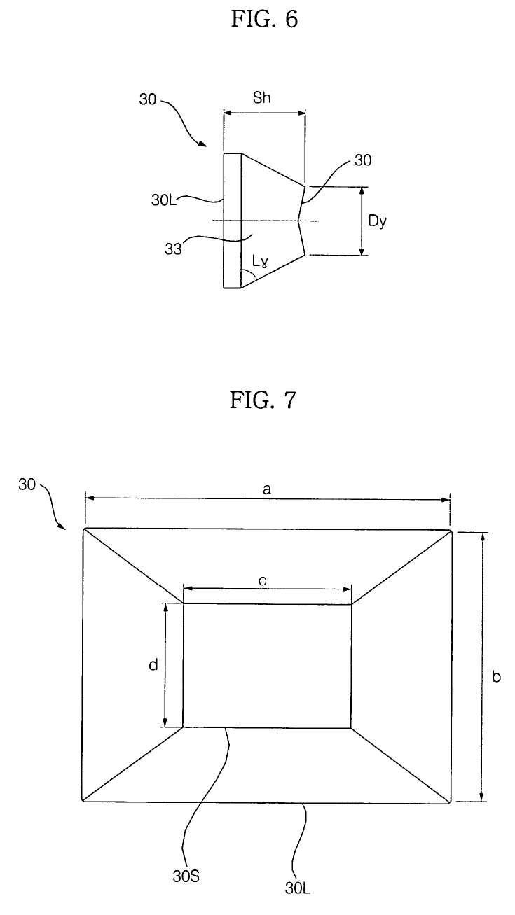

FIGS. 4 to 6 illustrate the inner shield according to the present invention that is capable of preventing the generation of halation and shadow on the screen. FIG. 4 is a plan view of the inner shield, FIG. 5 is a rear view of the inner shield, and FIG. 6 is a side view of the inner shield.

As shown in FIGS. 4 to 6, the inner shield 30 is formed approximately in the shape of a quadrangular pyramid having an inclined circumferential surface. At the front and the rear of the inner shield 30 are formed a small opening 30S and a large openings 30L, respectively, through which an electron beam passes.

The small opening 30S is formed at the electron gun side, and the large opening 30L is formed at the panel 21 side.

Referring back to FIG. 3, on the assumption that the linear distance from an electron beam deflection center C of the tube part 20 to the plane formed by the seal edge E of the panel 21 is L, and the height of the inner shield 30 is Sh, the inner shield 30 is constructed such that the following inequality is satisfied: 2<L/Sh<3.5.

On the assumption that the length of the major axis of the small opening 30S at the electron beam entrance side of the inner shield 30 is Dx, and the length of the minor axis of the small opening 30S at the electron beam entrance side of the inner shield 30 is Dy, the inner shield 30 is constructed such that the following inequalities are satisfied: 1.6<Dx/L<3.5 and 1.0<Dy/L<2.5.

Furthermore, on the assumption that the short side bent angle between the plane formed by the large opening 30L at the electron beam exit side of the inner shield 30 and each short side 33 is Sγ, the long side bent angle between the plane formed by the large opening 30L and each long side 31 is Lγ, the deflection angle forming the maximum deflection from the deflection center of the electron beam is Dθ, the inner shield 30 is constructed such that the following inequalities are satisfied: 2.5<Dθ/Sγ<6.5 and 1.0<Dθ/Lγ<3.0.

As described above, the ratio of the linear distance from an electron beam deflection center C of the tube part 20 to the plane formed by the seal edge E of the panel 21 to the height of the inner shield 30 (L/Sh), the ratio of the length of the major axis of the small opening 30S at the electron beam entrance side of the inner shield 30 and the length of the minor axis of the small opening 30S at the electron beam entrance side of the inner shield 30 to the linear distance from an electron beam deflection center C of the tube part 20 to the plane formed by the seal edge E of the panel 21 (Dx/L and Dy/L), and the ratio of the deflection angle forming the maximum deflection from the deflection center of the electron beam to the short side bent angle between the plane formed by the large opening 30L at the electron beam exit side of the inner shield 30 and the short side 33 and the long side bent angle between the plane formed by the large opening 30L and the long side 31 (Dθ/Sγ and Dθ/Lγ) are increased to the optimal values applicable to the slim cathode ray tubes.

Physical embodiments of the inner shield for slim cathode ray tubes with the above-stated construction according to the present invention will be described with reference to the following tables.

TABLE 3

| | | | | | Conventional |
|---|---|---|---|---|---|
| | Embodiment 1 | Embodiment 1 | Embodiment 1 | Embodiment 1 | Art |
| Deflection | 60 | 62.5 | 65 | 70 | 50 |
| angle | | | | | |
| (Dθ) | | | | | |
| L | 172 | 133 | 123 | 80 | 241 |
| Height | 65 | 59 | 52 | 30 | 140 |
| (Sh) | | | | | |
| Long | 282 | 264 | 258 | 220 | 317 |
| side of | | | | | |
| opening | | | | | |
| (Dx) | | | | | |
| Short | 180 | 170 | 166 | 142 | 172 |
| side of | | | | | |
| opening | | | | | |
| (Dy) | | | | | |
| Dx_MAX | 324 | 304 | 297 | 253 | 365 |
| Dy_MAX | 207 | 196 | 191 | 163 | 198 |
| Sγ_MIN | 20 | 13 | 12 | 11 | 37.6 |
| Sγ_MAX | 24 | 18 | 17 | 13 | 43 |
| Lγ_MIN | 40 | 30 | 25 | 23 | 57.5 |
| Lγ_MAX | 46 | 35 | 29 | 26 | 66 |
| L/Sh | 2.6 | 2.3 | 2.4 | 2.7 | 1.7 |
| Dx/L | 1.6 | 2.0 | 2.1 | 2.8 | 1.3 |
| Dx/L_MAX | 1.9 | 2.3 | 2.4 | 3.2 | 1.5 |
| Dy/L | 1.05 | 1.3 | 1.3 | 1.8 | 0.7 |
| Dy/L_MAX | 1.2 | 1.5 | 1.6 | 2.0 | 0.8 |
| Dθ/Sγ_MIN | 3.0 | 4.8 | 5.4 | 6.4 | 1.3 |
| Dθ/Sγ_MAX | 2.5 | 3.5 | 3.8 | 5.5 | 1.2 |
| Dθ/Lγ_MIN | 1.5 | 2.1 | 2.6 | 3.0 | 0.9 |
| Dθ/Lγ_MAX | 1.3 | 1.8 | 2.3 | 2.6 | 0.8 |

For the conventional inner shield, Dθ was 50, L was 241, Sh was 140, Dx was 317, Dy was 172, Sγ was 37.6 to 43, and the Lγ was 57.5 to 66, and therefore, L/Sh was 1.7, Dx/L was 1.3, Dy/L was 0.7, Dθ/Sγ was 1.2 to 1.3, and Dθ/Lγ was 0.8 to 0.9. When the conventional inner shield was applied to the wide-angle slim cathode ray tube having a deflection angle of 110 degrees or more, an electron beam emitted from the electron gun collided with the inner shield. As a result, shadow appeared on the screen.

For the inner shield according to Embodiment 1 of the present invention, on the other hand, Dθ was 60, L was 172, Sh was 65, Dx was 282, Dy was 180, Sγ was 20 to 24, and the Lγwas 40 to 46, and therefore, L/Sh was 2.6, Dx/L was 1.6, Dy/L was 1.05, Dθ/Sγ was 2.5 to 3.0, and Dθ/Lγ was 1.3 to 1.5.

For the inner shield according to Embodiment 2 of the present invention, Dθ was 62.5, L was 133, Sh was 59, Dx was 264, Dy was 170, Sγ was 13 to 18, and the Lγ was 30 to 35, and therefore, L/Sh was 2.3, Dx/L was 2.0, Dy/L was 1.3, Dθ/Sγ was 3.5 to 4.8, and Dθ/Lγ was 1.8 to 2.1.

For the inner shield according to Embodiment 3 of the present invention, Dθ was 65, L was 123, Sh was 52, Dx was 258, Dy was 166, Sγ was 12 to 17, and the Lγ was 25 to 29, and therefore, L/Sh was 2.4, Dx/L was 2.1, Dy/L was 1.3, Dθ/Sγ was 3.8 to 5.4, and Dθ/Lγ was 2.3 to 2.6.

For the inner shield according to Embodiment 4 of the present invention, Dθ was 70, L was 80, Sh was 30, Dx was 220, Dy was 142, Sγ was 11 to 13, and the Lγ was 23 to 26, and therefore, L/Sh was 2.7, Dx/L was 2.8, Dy/L was 1.8, Dθ/Sγ was 5.5 to 6.4, and Dθ/Lγ was 2.6 to 3.0.

As described above, the inner shield 30 according to each of the four embodiments of the present invention was constructed such that L/Sh was 2 to 3.5, and therefore, when the inner shield 30 according to each of the four embodiments of the present invention was mounted in the tube part 20 of the slim cathode ray tube, interference was not generated between the inner shield 30 and the funnel 23. Consequently, the assembly efficiency was improved, and halation, which may be generated by an overscanned electron beam, was effectively prevented.

Furthermore, the inner shield 30 according to the present invention was constructed such that Dx/L was 1.6 to 3.5, Dy/L was 1.0 to 2.5, Dθ/Sγ was 2.5 to 6.5, and Dθ/Lγ was 1.0 to 3.0, and therefore, the sizes Dx and Dy of the entrance-side small opening 30S were appropriately set. As a result, when the inner shield 30 according to the present invention was applied to the slim cathode ray tube, the electron beam emitted from the electron gun passed through the entrance-side small opening 30S without interference, and then the electron beam passed through the shadow mask 25 to irradiate the fluorescent body of the panel 21. Consequently, the phenomenon that shadow appeared on the screen by the electron beam colliding with the inner shield 30 was eliminated.

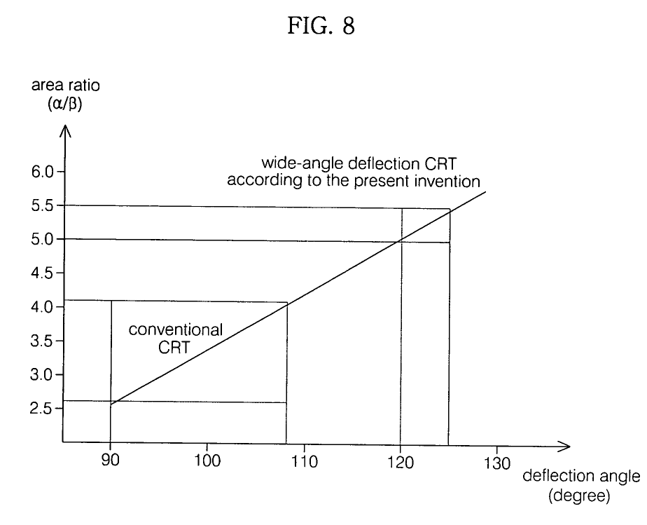

FIG. 7 is a schematic front view illustrating the ratio of openings of the inner shield according to the present invention, and FIG. 8 is a graph illustrating the relationship between the deflection angle of the cathode ray tube and the area ratio of the openings.

The height of the inner shield 30 is decreased in relation to the wide-angle deflection of the slim cathode ray tube, and therefore, the volume of the inner shield 30 is reduced. For this reason, it is important to reduce the area of the opening, through which the electron beam is introduced, such that the electron beam can be maximally enclosed by the inner shield 30, so as to prevent the reduction of the external magnetic field shielding efficiency, when the inner shield 30 is applied to the slim cathode ray tube having wide-angle deflection of 120 degrees or more.

On the assumption that the horizontal length of the large opening 30L of the inner shield 30 is a, the vertical length of the large opening 30L is b, and the area of the large opening 30L is α while the horizontal length of the small opening 30S of the inner shield 30 is c, the vertical length of the small opening 30S is d, and the area of the small opening 30S is β, the ratio in area of the large opening 30L to the small opening 30S is set such that the following inequality is satisfied: 5.5>α/β>5.0.

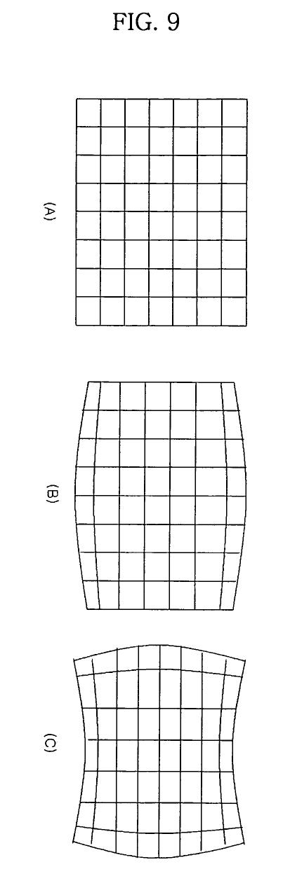

The above-described area ratio may be set with reference to FIGS. 9A to 9C. For the conventional cathode ray tube, the deflection angle is normally from 90 to 110 degrees, and therefore, the area ratio (α/β) is 2.7 to 4.1. For the slim cathode ray tube according to the present invention, on the other hand, when the deflection angle is between 120 degrees and 125 degrees, the ratio in area of the large opening 30L to the small opening 30S (α/β) is preferably set to 5.0 to 5.5.

Consequently, when the area ratio of the openings is set as described above, a normal raster pattern appears as shown in FIG. 9A. When the height of the inner shield is increased, and therefore, the area ratio of the openings is decreased, however, a raster pattern, in which the deflection region of the deflection yoke is invaded, appears as shown in FIG. 9B. When the height of the inner shield is decreased, and therefore, the area ratio of the openings is increased, on the other hand, the external magnetic field shielding efficiency is lowered, and therefore, a raster pattern, which is partially distorted, appears as shown in FIG. 9C.

Meanwhile, it is preferable to form the large opening 30L and the small opening 30S such that the horizontal length a of the large opening 30L and the vertical length b of the large opening 30L are double or more the horizontal length c of the small opening 30S and the vertical length d of the small opening 30S, respectively, whereby the above-described conditions are satisfied.

Alternatively, it is possible to form the large opening 30L and the small opening 30S such that the horizontal length a of the large opening 30L is double or more the horizontal length c of the small opening 30S, or the vertical length b of the large opening 30L is double or more the vertical length d of the small opening 30S.

When the inner shield 30 according to the present invention, which satisfies the above-described conditions, is applied to a 29-inch cathode ray tube, the dimensions of the inner shield 30 are set as indicated in Table 4 and Table 5 below.

TABLE 4
Unit: mm

| Model | a | b | c | d |
|---|---|---|---|---|
| 29 | 0.500 | 0.380 | 0.220 | 0.160 |

TABLE 5

Unit: m²

| Model | α | β | α/β | a/c | b/d |
|---|---|---|---|---|---|
| 29 | 0.190 | 0.035 | 5.4 | 2.27 | 2.38 |

The area β of the small opening 30S of the inner shield 30 according to the present invention indicated in Table 5 is decreased to half that of the conventional 29-inch cathode ray tube indicated in Table 2 by virtue of the wide-angle deflection.

When the area β of the small opening 30S, through which the electron beam emitted from the electron gun is introduced, is decreased as described above, the space through which the electron beam passes is maximally enclosed, and therefore, the external magnetic field shielding efficiency is improved.

Consequently, the ratio in area of the large opening 30L to the small opening 30S of the inner shield 30 (α/β) is set to 5.0 to 5.5, i.e., the area β of the small opening 30S is considerably reduced as compared to the conventional inner shield, and therefore, the inner shield 30 according to the present invention has sufficient external magnetic field shielding efficiency when the inner shield 30 is applied to the slim cathode ray tube.

As apparent from the above description, the height of the inner shield and the sizes of the openings of the inner shield are appropriately set to construct the inner shield for slim cathode ray tube according to the present invention. Consequently, when the inner shield is applied to the slim cathode ray tube, interference is not generated between the inner shield and the funnel, and therefore, the assembly efficiency is improved, halation, which may be generated by an overscanned electron beam, is prevented, and the appearance of shadow on the screen is also prevented.

Furthermore, the inner shield for slim cathode ray tubes according to the present invention is constructed such that the area of the opening, through which the electron beam is introduced, is reduced, and therefore, the electron beam can be maximally enclosed by the inner shield. As a result, the height of the inner shield is reduced in relation to the wide-angle deflection, and therefore, the reduction of the external magnetic field shielding efficiency is prevented even though the volume of the inner shield is reduced. Consequently, the reliability of the shielding function is improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An inner shield for slim cathode ray tubes, wherein
on the assumption that the linear distance from an electron beam deflection center of a tube part to the plane formed by a seal edge of a panel is L, and the height of the inner shield is Sh, the inner shield is constructed such that the following inequality is satisfied: 2<L/Sh<3.5,
on the assumption that the length of the major axis of an opening at the electron beam entrance side of the inner shield is Dx, and the length of the minor axis of the opening at the electron beam entrance side of the inner shield is Dy, the inner shield is constructed such that the following inequalities are satisfied: 1.6<Dx/L<3.5 and 1.0<Dy/L<2.5,
the inner shield has a wide-angle deflection of 120 degrees or more, and
on the assumption that the area of a large opening at the panel side is α, and the area of a small opening at the electron gun side is β, the ratio in area of the large opening to the small opening is set such that the following inequality is satisfied: 5.5>α/β>5.0.

2. An inner shield for slim cathode ray tubes, wherein on the assumption that the linear distance from an electron beam deflection center of a tube part to the plane formed by a seal edge of a panel is L, and the height of the inner shield is Sh,
the inner shield is constructed such that the following inequality is satisfied: 2<L/Sh<3.5.

3. The inner shield as set forth in claim 2, wherein on the assumption that the length of the major axis of an opening at the electron beam entrance side of the inner shield is Dx,
the inner shield is constructed such that the following inequality is satisfied: 1.6<Dx/L<3.5.

4. The inner shield as set forth in claim 2, wherein on the assumption that the length of the minor axis of an opening at the electron beam entrance side of the inner shield is Dy,
the inner shield is constructed such that the following inequality is satisfied: 1.0<Dy/L<2.5.

5. The inner shield as set forth in claim 2, wherein
on the assumption that the short side bent angle between the plane formed by an opening at the electron beam exit side of the inner shield and each short side is Sγ, and the deflection angle forming the maximum deflection from the center of an electron beam is Dθ,
the inner shield is constructed such that the following inequality is satisfied: 2.5<Dθ/Sγ<6.5.

6. The inner shield as set forth in claim 2, wherein
on the assumption that the long side bent angle between the plane formed by an opening at the electron beam exit side of the inner shield and each long side is Lγ, and the deflection angle forming the maximum deflection from the center of an electron beam is Dθ,
the inner shield is constructed such that the following inequality is satisfied: 1.0<Dθ/Lγ<3.0.

7. An inner shield for slim cathode ray tubes, wherein
the inner shield has a wide-angle deflection of 120 degrees or more, and
on the assumption that the area of a large opening at the panel side is α, and the area of a small opening at the electron gun side is β,
the ratio in area of the large opening to the small opening is set such that the following inequality is satisfied: 5.5>α/β>5.0.

8. The inner shield as set forth in claim 7, wherein
on the assumption that the horizontal length of the large opening is a, the vertical length of the large opening is b, the horizontal length of the small opening is c, and the vertical length of the small opening is d,
a and b of the large opening are double or more c and d of the small opening, respectively.

9. The inner shield as set forth in claim 7, wherein
on the assumption that the horizontal length of the large opening is a, and the horizontal length of the small opening is c,
a of the large opening is double or more c of the small opening.

10. The inner shield as set forth in claim 7, wherein
on the assumption that the vertical length of the large opening is b, and the vertical length of the small opening is d,
b of the large opening is double or more d of the small opening.

11. An inner shield for slim cathode ray tubes, wherein
on the assumption that the linear distance from an electron beam deflection center of a tube part to the plane formed by a seal edge of a panel is L, the length of the major axis of an opening at the electron beam entrance side of the inner shield is Dx, and the length of the minor axis of the opening at the electron beam entrance side of the inner shield is Dy,
the inner shield is constructed such that the following inequalities are satisfied: 1.6<Dx/L<3.5 and 1.0<Dy/L<2.5.

12. The inner shield as set forth in claim 11, wherein
on the assumption that the short side bent angle between the plane formed by an opening at the electron beam exit side of the inner shield and each short side is Sγ, and the deflection angle forming the maximum deflection from the center of an electron beam is Dθ,
the inner shield is constructed such that the following inequality is satisfied: 2.5<Dθ/Sγ<6.5.

13. The inner shield as set forth in claim 11, wherein
on the assumption that the long side bent angle between the plane formed by an opening at the electron beam exit side of the inner shield and each long side is Lγ, and the deflection angle forming the maximum deflection from the center of an electron beam is Dθ,
the inner shield is constructed such that the following inequality is satisfied: 1.0<Dθ/Lγ<3.0.

14. The inner shield as set forth in claim 11, wherein
on the assumption that the short side bent angle between the plane formed by an opening at the electron beam exit side of the inner shield and each short side is Sγ, the long side bent angle between the plane formed by an opening at the electron beam exit side of the inner shield and each long side is Lγ, and the deflection angle forming the maximum deflection from the center of an electron beam is Dθ,
the inner shield is constructed such that the following inequalities are satisfied: 2.5<Dθ/Sγ<6.5 and 1.0<Dθ/Lγ<3.0.

15. The inner shield as set forth in claim 11, wherein
on the assumption that the height of the inner shield is Sh,
the inner shield is constructed such that the following inequality is satisfied: 2<L/Sh<3.5.
